(19) United States
(12) Patent Application Publication
(10) Pub. No.: US 2015/0158514 A1
(43) Pub. Date: Jun. 11, 2015

(54) STAIR CLIMBING ARRANGEMENT AND ASSEMBLY

(71) Applicant: On The Level Billiards, LLC, Torrington, CT (US)

(72) Inventor: John Palmer, Torrington, CT (US)

(73) Assignee: On The Level Billiards, LLC, Torrington, CT (US)

(21) Appl. No.: 14/103,139

(22) Filed: Dec. 11, 2013

(51) Int. Cl. B62B 1/02; B62B 1/26

(52) U.S. Cl. CPC B62B 1/02; B62B 1/268

(57) ABSTRACT

A stair climbing arrangement includes at least one wheel attachable to an article to be transported up a flight of stairs, at least one receiver in operable communication with the at least one wheel and a lever pivotally engagable with the at least one receiver. The lever is positioned such that a first portion thereof is extended past the receiver on one side and a second portion is extendable on an opposing side. The first portion is engagable with a step of the flight of stairs such that lifting of the second portion causes the at least one receiver, the at least one wheel and the article to be lifted relative to the step.

### BACKGROUND

Moving of heavy sheets of material, such as sheets of slate for pool tables, for example, can be awkward and difficult, especially when moving them up or down flights of stairs. Hand trucks can be employed that allow the weight of the sheet to be supported by the truck while being moved. Guiding the sheet so that its weight remains supported by the truck during such moves can be difficult, particularly when the center of gravity of the sheet is not directly above the wheels of the hand truck. Ropes and strapping can help maintain the sheet to the truck but are difficult to secure to prevent relative movement between the sheet and the truck. As such, the art is always receptive to devices to make handling of moving sheets simpler and safer.

### BRIEF DESCRIPTION

Disclosed herein is a stair climbing arrangement. The arrangement includes at least one wheel attachable to an article to be transported up a flight of stairs, at least one receiver in operable communication with the at least one wheel and a lever pivotally engagable with the at least one receiver. The lever is positioned such that a first portion thereof is extended past the receiver on one side and a second portion is extendable on an opposing side. The first portion is engagable with a step of the flight of stairs such that lifting of the second portion causes the at least one receiver, the at least one wheel and the article to be lifted relative to the step.

Further disclosed herein is an assembly. The assembly includes, a clamp configured to disconnectably attach to an article through frictional compression against opposing sides of the article and a clip disconnectably attachable to the clamp at at least one selected location, having a sleeve axially slidably releasably receptive to a rigid bar servable as a handle to help control movement of the article.

### BRIEF DESCRIPTION OF THE DRAWINGS

The following descriptions should not be considered limiting in any way. With reference to the accompanying drawings, wherein like elements are numbered alike:

FIG. 1 depicts a perspective view of an embodiment of an assembly having a clamp and clip disclosed herein;

FIG. 2 depicts another perspective view of an embodiment of an assembly including the clamp and the clip of FIG. 1;

FIG. 3 depicts a perspective view of an alternate embodiment of an assembly disclosed herein;

FIG. 4 depicts a perspective view of an alternate embodiment of the assembly disclosed herein;

FIG. 5 depicts a perspective view of an embodiment of a sheet stair climbing kit disclosed herein;

FIG. 6 depicts a perspective view of an alternate embodiment of a sheet stair climbing kit disclosed herein;

FIG. 7 depicts a perspective view of an embodiment of a stair climbing arrangement disclosed herein;

FIG. 8 depicts an alternate perspective view of the stair climbing arrangement of FIG. 7; and

FIG. 9 depicts a schematical side view of the stair climbing arrangement of FIG. 7.

### DETAILED DESCRIPTION

A detailed description of one or more embodiments of the disclosed apparatus and method are presented herein by way of exemplification and not limitation with reference to the Figures.

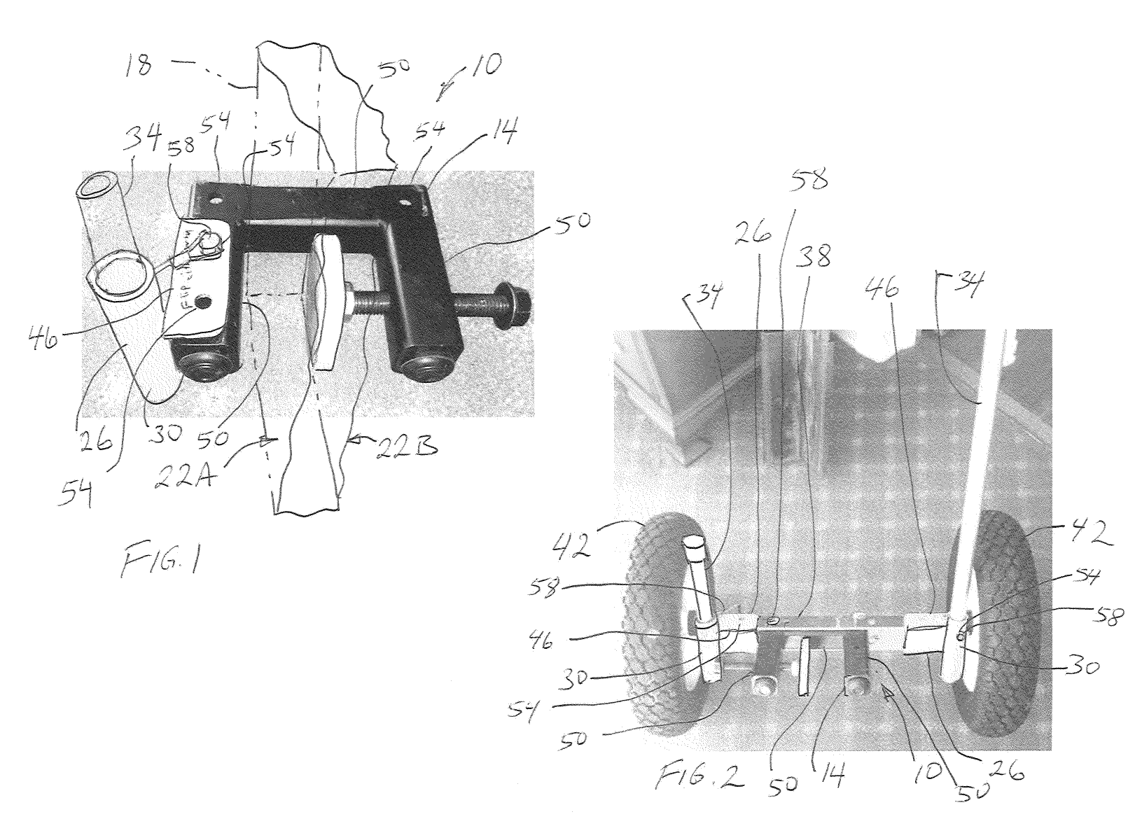

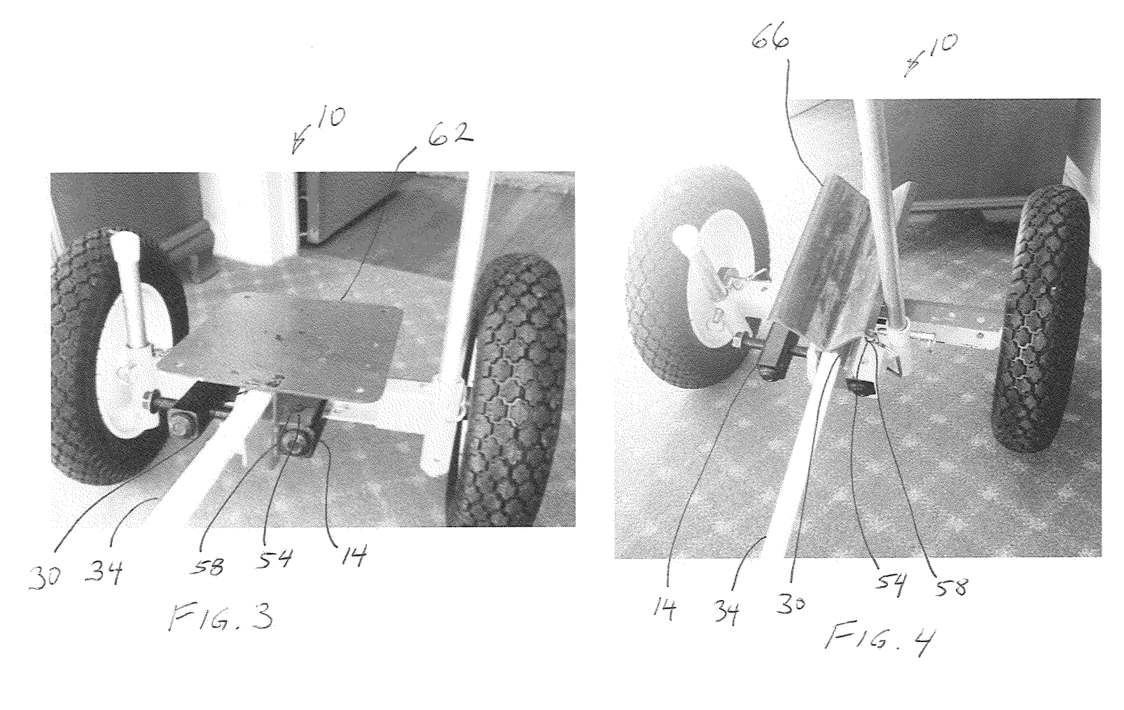

Referring to FIGS. 1 and 2, an embodiment of an assembly disclosed herein is illustrated at 10. The assembly 10 includes a clamp 14 configured to disconnectably attach to an article 18 (partially transparently illustrated as a sheet of slate in phantom lines in FIG. 1 only). In this embodiment the clamp 14 disconnectably attaches to the article 18 through frictional compression against opposing sides 22A, 22B of the article 18. A clip 26 is disconnectably attachable to the clamp 14 at at least one selected location and has a sleeve 30 that is axially slidably receptive to a rigid bar 34. The foregoing assembly 10 allows the rigid bar 34 to serve as a handle to help control movement of the article 18.

Referring to FIG. 2 specifically, an axle assembly 38 is disconnectably attachable to the clamp 14 and is receptive to one or more wheels 42, with two being illustrated, which are rotatably mounted thereon. One or more of the clips 26 are also attachable to the axle assembly 38 in selected locations. As such, the article 18, an otherwise difficult to handle and possibly very heavy sheet of material, can, once clamped by the clamp 14, be easily moved about simply by grasping one or more of the rigid bars 34 and rolling the complete assembly on the wheels 42.

The clip 26 and the axle assembly 38 each have a portion 46 with a cross sectional shape of a C-channel that is sized to engage about a rectangular cross sectional shape of a leg 50 of the clamp 14. The portions 46 and the legs 50 have features 54, disclosed in this embodiment as holes, that are receptive to fasteners 58 such as pins or bolts, for example, that fixedly attach the clip 26 and/or the axle assembly 38 to the clamp 14 once installed in the feature 54. By providing a plurality of the features 54 in each of the portions 46 and the legs 50, an operator has the flexibility of selecting where to attach the clips 26 and the axle assembly 38 to the clamp 14. Additionally, the legs 50 and the portions 46 can be sized such that a single one of the fasteners 58 can fixedly attached both one of the clips 26 and the axle assembly 38 to one of the clamps 14. Similarly, the sleeves 30 and the rigid bars 34 can have one or more of the features 54 therein also receptive to the fasteners 58 to facilitate quickly and easily attaching one of the rigid bars 34 to one of the sleeves 30 in one of a plurality of selectable positions.

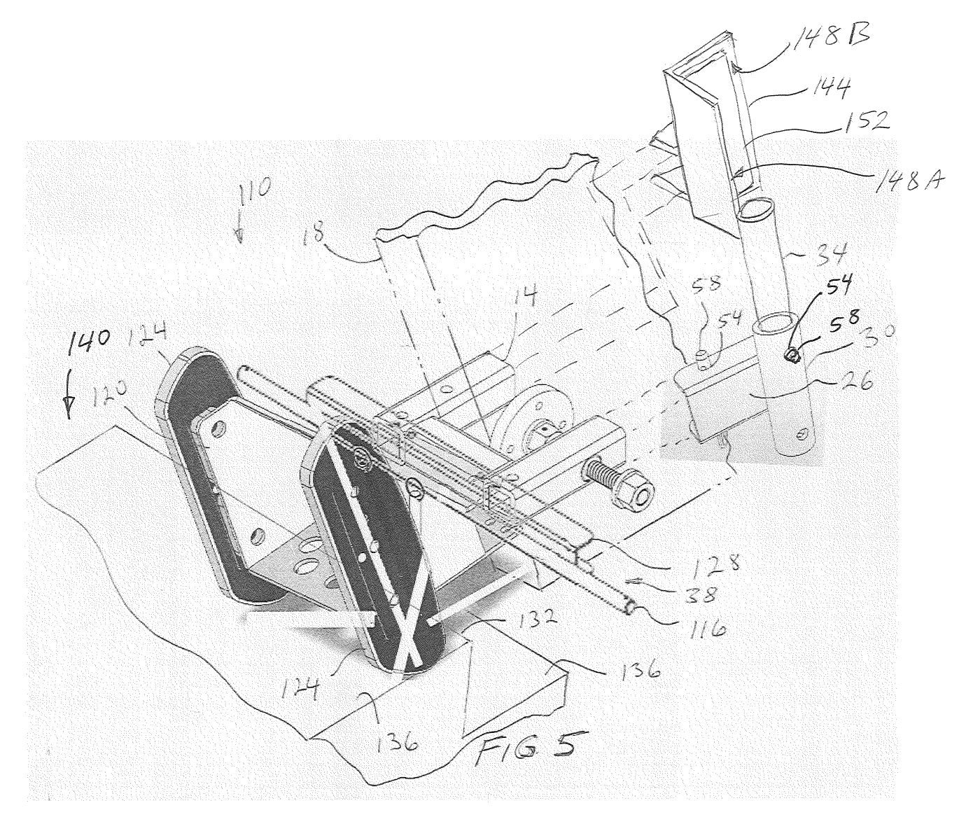

Referring to FIG. 3, an alternate embodiment of the assembly 10 includes a flat plate 62 fixedly attached to the clamp 14 via one of the fasteners 58 engaged with features 54 in both the flat plate 62 and the clamp 14. The flat plate 62 also includes one or more of the sleeves 30 with one or more of the features 58 (not visible in the view of the Figure) for receptively locking one of the rigid bars 34 thereto with one of the fasteners 58.

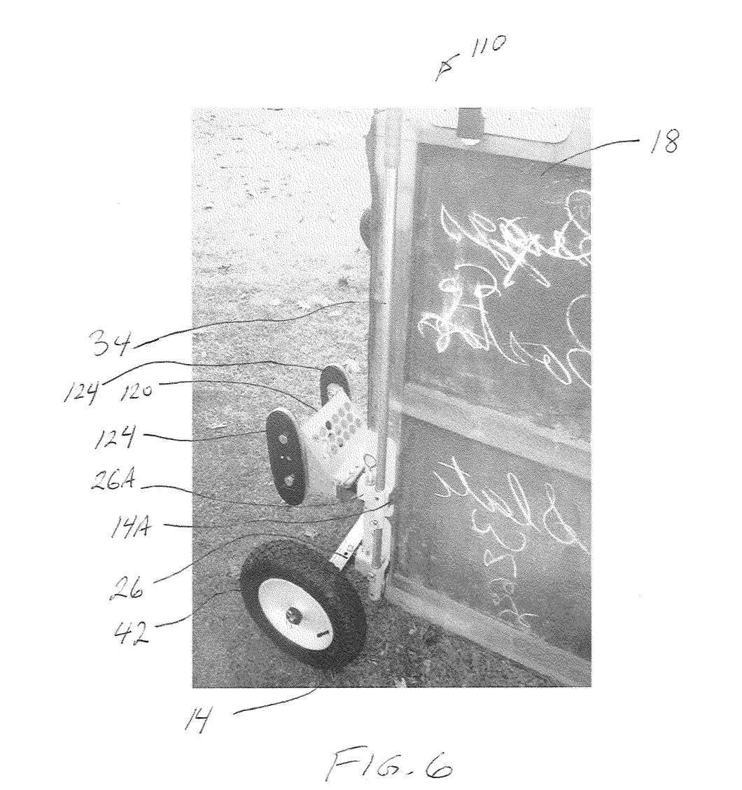

Referring to FIG. 4, another alternate embodiment of the assembly 10 includes a V-channel 66 fixedly attached to the clamp 14 via one of the fasteners 58 engaged with features 54 in both the V-channel 66 and the clamp 14. The V-channel 66 also includes one or more of the sleeves 30 with one or more of the features 58 (not visible in the view of the Figure) for receptively locking one of the rigid bars 34 thereto with one of the fasteners 58.

Referring to FIG. 5, a sheet stair climbing kit is illustrated at 110. The sheet stair climbing kit 110 includes the axle assembly 38, the clip 26 with the rigid bar 34 engaged therewith, and the clamp 14 configured to securely clamp the sheet 18 in an orientation substantially perpendicular to an axle 116 of the axle assembly 38. The kit 110 also includes a stair attachment 120 having at least one glide 124, with two being illustrated, that is disconnectably attachable to at least one of the axle assembly 38 and the clamp 14 in at least one selected position configured to orient the glides 124 in an orientation substantially parallel to the sheet 18. The glides 124 in this embodiment are positioned on opposing sides of the sheet 18. The axle assembly 38 includes a C-channel 128 that also has the features 54 that define selected positions for attachment of the axle assembly 38 to other components of the kit 110.

The sheet stair climbing kit 110 when assembled and arranged as in FIG. 5 preferentially positions the glides 124 to contact edges 132 of steps 136 while moving the sheet 18, clamped therein, up or down a flight of stairs 140. More specifically, the axle assembly 38 positions a pair of the wheels 42 (not shown in this view) attachable thereto relative to the sheet 18 such that when the wheels 42 are resting on one step 136 the glides 124 are resting against the next step 136 above the one the wheels are resting upon. Further, the kit 110 as assembled locates the rotational center of the wheels 42 below the edge 132 yet allows an operator to easily pivot the kit 110 about a contact point between the glides 124 and the edge 132 thereby lifting the rotational center of the wheels 42 above the edge 132. Alternately or in addition to rotating about the contact point the kit 110 can be slid along the edge 132 on the glides 124 thereby lifting the rotational center of the wheels 42 above the edge 132 with greater ease than if the wheels 42 were required to roll up and over the edge 132. Once the wheels 42 contact the edge 132 while their rotational center is above the edge 132 the complete kit 110 and sheet 18 assembly is much easier to lift to the point where the wheels 42 are resting on the next higher of the steps 136. This process is fully reversible to simplify moving down the flight of stairs 140 as well.

Optionally, shown in FIG. 5 is a slate shoe 144. The slate shoe 144 disconnectably attaches to at least the clamp 14 in selected positions in a similar manner as that employed by the clip 26. The slate shoe 144, as illustrated in this embodiment, includes two surfaces 148A, 148B. The surface 148A helps align and support the sheet 18 relative to the kit 110 while the surface 148B provides a larger area over which to distribute clamping loads than is provided by the clamp 14 alone. Additionally, one or both of the surfaces 148A and 148B may have a pad 152 attached thereto to, for example, increase frictional engagement with the sheet 18.

Referring to FIG. 6, the kit 110 provides for attaching an additional one of the clamps 14A to the sheet 18 at another location, such as above the first of the clamps 14, for example, as illustrated. The second of the clamps 14A allows additional control regarding attachment and positioning of the stair attachment 120 relative to the wheels 42. Such adjustability is convenient when moving the sheet 18 up or down steps of greater than normal heights, for example.

The kit 110 also allows for attaching a second one of the clips 26A to the second clamp 14A. So doing allows one to add a second of the rigid bars, or as illustrated, to attach a single one of the rigid bars 34 to both of the clips 26 and 26A, thereby providing greater stability between the rigid bar 34 and the sheet 18 being moved.

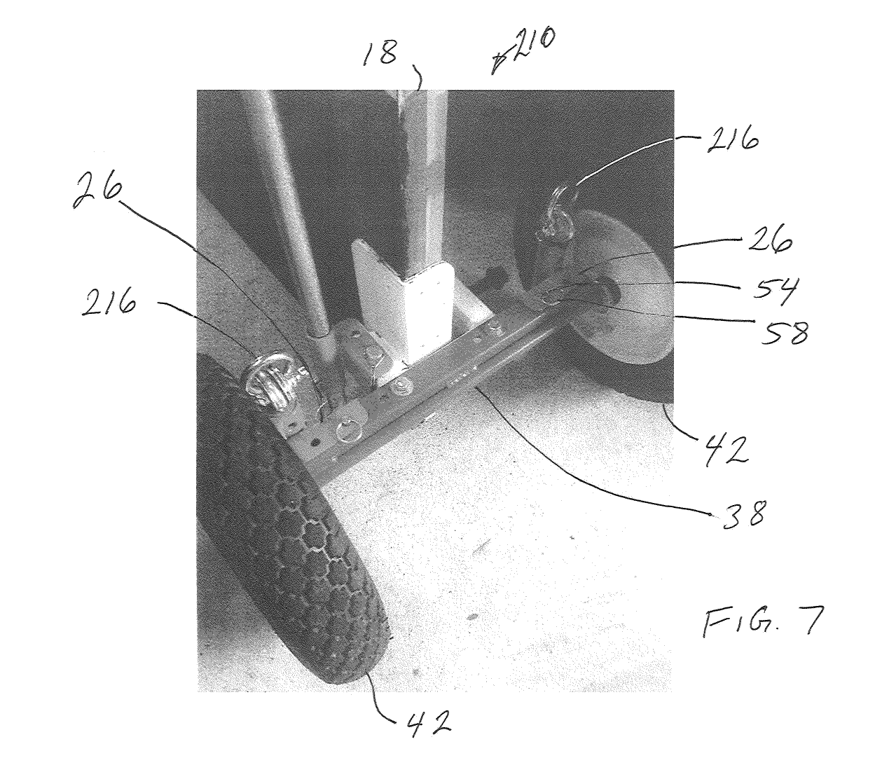

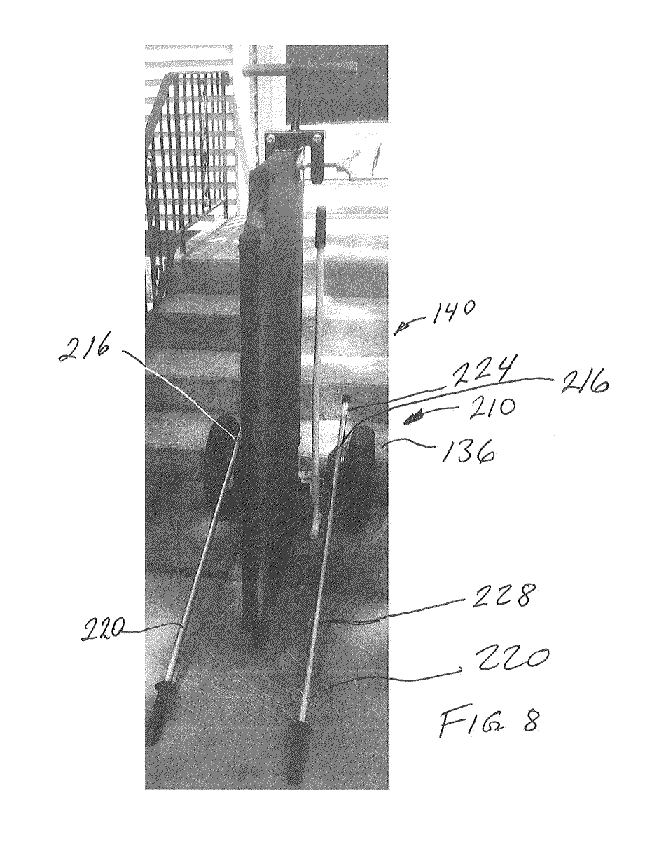

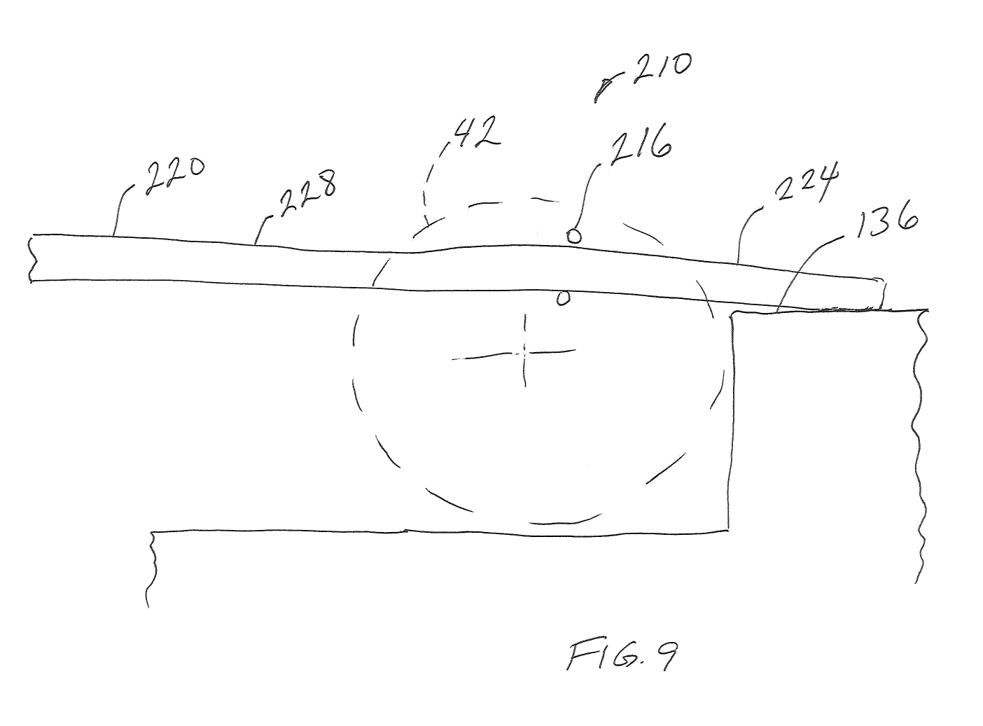

Referring to FIGS. 7-9, a stair climbing arrangement disclosed herein is illustrated at 210. The stair climbing arrangement 210 includes, at least one wheel 42 (with two of the wheels 42 being shown in the illustrated embodiment) being attached to an article 18 to be transported up the flight of stairs 140 (FIG. 8). The arrangement 210 further includes at least one receiver 216 (with two being shown in the embodiment) in operable communication with the wheels 42 and a lever 220 pivotally engagable with the receivers 216 such that a first portion 224 of the lever 220 is extendable past the receiver 216 on one side of the receiver 216 and a second portion 228 of the lever 220 is extendable on an opposite side of the receiver 216 than the first portion 224. The first portion 224 is engagable with the steps 136 of the flight of stairs 140 such that lifting of the second portion 228 causes the receiver 216, the wheels 42 and the article 18 to be lifted relative to the steps 136.

The receiver 216 includes an eyelet, shackle, hook or other feature that is slidably receptive to the lever 220. As such the lever 220 can be easily slid through the receiver 216 to allow the first portion 224 to be positioned on the next higher step 136 than the wheel 42 is currently resting while ascending the flight of stairs 140. The stair climbing arrangement 210 is configured such that the second portion 228 is above the first portion 224 as the wheels 42 are being lifted in response to lifting of the second portion 228, as best shown in FIG. 9.

The receiver 216 is attachable to one of the clips 26 via fasteners 58 that engage with features 54 in a similar manner as to how the rigid bar 34 is attached to the clip 26 discussed above. Once the receiver 216 is attached to the clip 26, the clip 26 can be attached to the clamp 14 as was discussed with reference to FIG. 1, or the clip 26 can be attached to the axle assembly 38 as discussed with reference to FIG. 2 and as shown in FIG. 7.

The modularity of the stair climbing arrangement 210 provided by the clip 26 being receptive to both the rigid bar 34 and the receiver 216, and the clip 26 being attachable to the clamp 14 and the axle assembly 38, for example, allows for one or more of the receivers 216 to be employed in the arrangement 210. When employing two of the receivers 216 as in the illustrated embodiment, two of the levers 220 can be used simultaneously to lift the article 18 relative to one of the steps 136. Use of two of the levers 220 at the same time can provide an additional level of symmetry while lifting the article 18.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. An assembly, comprising:
a clamp configured to disconnectably attach to an article through frictional compression against opposing sides of the article; and
a clip disconnectably attachable to the clamp at at least one selected location, having a sleeve axially slidably releasably receptive to a rigid bar servable as a handle to help control movement of the article.

2. The assembly of claim 1, further comprising a shoe for increasing an area over which the frictional compression is applied to at least one side of the article.

3. The assembly of claim 2, wherein the shoe is disconnectably attachable to the clamp.

4. The assembly of claim 2, wherein the shoe includes a pad configured to increase frictional engagement between the shoe and the article.

5. The assembly of claim 2, wherein the shoe includes at least two surfaces that are positioned to make contact with the article.

6. The assembly of claim 2, wherein one or more fasteners the same as the fasteners that disconnectably attach the clip to the clamp can also disconnectably attach the shoe to the clamp.

7. The assembly of claim 2, wherein one or more fasteners the same as the fasteners that disconnectably attach the clip to the clamp can also disconnectably attach the rigid bar to the sleeve.

8. The assembly of claim 1, further comprising an axle assembly receptive to one or more wheels rotatably mountable to the axle assembly, the axle assembly being disconnectably attachable to the clamp.

9. The assembly of claim 8, further comprising a receiver attachable to the axle assembly, the receiver being receptive to a lever pivotally engagable with the receiver such that a first portion of a lever is extendable past the receiver on one side of the receiver and a second portion of the lever is extendable on an opposite side of the receiver than the first portion, the first portion being sequentially engagable with a step of a flight of stairs such that lifting of the second portion causes the receiver, the one or more wheels and the article to be lifted relative to the step.

10. A stair climbing arrangement, comprising:
at least one wheel attachable to an article to be transported up a flight of stairs;
at least one receiver in operable communication with the at least one wheel; and
a lever pivotally engagable with the at least one receiver such that a first portion of a lever is extendable past the at least one receiver on one side of the at least one receiver and a second portion of the lever is extendable on an opposite side of the at least one receiver than the first portion, the first portion being engagable with a step of the flight of stairs such that lifting of the second portion causes the at least one receiver, the at least one wheel and the article to be lifted relative to the step.

11. The stair climbing arrangement of claim 10, wherein the at least one receiver includes an eyelet, a shackle or a hook.

12. The stair climbing arrangement of claim 10, wherein the at least one receiver is positioned above a rotational center of the at least one wheel.

13. The stair climbing arrangement of claim 10, wherein the stair climbing arrangement is configured such that the second portion of the lever is above the first portion of the lever as the at least one wheel is lifted.

14. The stair climbing arrangement of claim 10, wherein the at least one receiver is two receivers, and each of the two receivers is positioned on opposing sides of the article.

15. The stair climbing arrangement of claim 10, wherein the lever and the at least one receiver are sized to allow the lever to be easily longitudinally moved relative to the at least one receiver.

16. The stair climbing arrangement of claim 10, further comprising an axle assembly the at least one receiver and the at least one wheel being attachable to the axle assembly.

17. The stair climbing arrangement of claim 16, wherein the article is attached to the axle assembly with a clamp.
